(19) United States
(12) Patent Application Publication
(10) Pub. No.: US 2018/0074903 A1
(43) Pub. Date: Mar. 15, 2018

(54) PROCESSING ACCESS REQUESTS IN A DISPERSED STORAGE NETWORK

(71) Applicant: International Business Machines Corporation, Armonk, NY (US)

(72) Inventors: Wesley B. Leggette, Chicago, IL (US); Andrew D. Baptist, Mt. Pleasant, WI (US); Ilya Volvovski, Chicago, IL (US)

(21) Appl. No.: 15/816,824

(22) Filed: Nov. 17, 2017

Related U.S. Application Data
(63) Continuation-in-part of application No. 15/242,858, filed on Aug. 22, 2016.
Application No. 15/242,858 is a continuation of application No. 14/256,205, filed on Apr. 18, 2014, now Pat. No. 9,424,132.
(60) Provisional application No. 61/828,883, filed on May 30, 2013.

(51) Int. Cl. G06F 11/10; G06F 11/30; H04L 29/08; G06F 3/06; G06F 11/34; G06F 11/14

(52) U.S. Cl. CPC G06F 11/1092; G06F 11/3034; H04L 67/10; G06F 3/067; G06F 3/0659; G06F 3/064; G06F 11/3433; G06F 11/3419; G06F 11/1458; G06F 11/1456; G06F 11/1453; G06F 11/349; G06F 11/3485; G06F 3/0619; G06F 3/06; G06F 2211/1028

(57) ABSTRACT

A method for execution by a director module includes receiving an access request that includes a searchable identifier. A dispersed hierarchical index is searched using the searchable identifier to identify a resource group. Group access information that includes the access request is issued to an access module associated with the resource group. The access module accesses a DSN memory based on the group access information and updates the dispersed hierarchical index with regards to the resource group. Further group access information is received from the access module. An access response is issued to a requesting entity based on the further group access information.

### CROSS-REFERENCE TO RELATED APPLICATIONS

The present U.S. Utility patent application claims priority pursuant to 35 U.S.C. § 120 as a continuation-in-part of U.S. Utility application Ser. No. 15/242,858, entitled “ADJUSTING DISPERSED STORAGE NETWORK TRAFFIC DUE TO REBUILDING”, filed Aug. 22, 2016, which is a continuation of U.S. Utility application Ser. No. 14/256,205, entitled “ADJUSTING DISPERSED STORAGE NETWORK TRAFFIC DUE TO REBUILDING”, filed Apr. 18, 2014, issued as U.S. Pat. No. 9,424,132 on Aug. 23, 2016, which claims priority pursuant to 35 U.S.C. § 119(e) to U.S. Provisional Application No. 61/828,883, entitled “ACCESSING DATA IN A DISPERSED STORAGE NETWORK”, filed May 30, 2013, all of which are hereby incorporated herein by reference in their entirety and made part of the present U.S. Utility patent application for all purposes.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

### Technical Field of the Invention

This invention relates generally to computer networks and more particularly to dispersing error encoded data.

### Description of Related Art

Computing devices are known to communicate data, process data, and/or store data. Such computing devices range from wireless smart phones, laptops, tablets, personal computers (PC), work stations, and video game devices, to data centers that support millions of web searches, stock trades, or on-line purchases every day. In general, a computing device includes a central processing unit (CPU), a memory system, user input/output interfaces, peripheral device interfaces, and an interconnecting bus structure.

As is further known, a computer may effectively extend its CPU by using “cloud computing” to perform one or more computing functions (e.g., a service, an application, an algorithm, an arithmetic logic function, etc.) on behalf of the computer. Further, for large services, applications, and/or functions, cloud computing may be performed by multiple cloud computing resources in a distributed manner to improve the response time for completion of the service, application, and/or function. For example, Hadoop is an open source software framework that supports distributed applications enabling application execution by thousands of computers.

In addition to cloud computing, a computer may use “cloud storage” as part of its memory system. As is known, cloud storage enables a user, via its computer, to store files, applications, etc. on an Internet storage system. The Internet storage system may include a RAID (redundant array of independent disks) system and/or a dispersed storage system that uses an error correction scheme to encode data for storage.

### BRIEF DESCRIPTION OF THE SEVERAL VIEWS OF THE DRAWING(S)

FIG. 1 is a schematic block diagram of an embodiment of a dispersed or distributed storage network (DSN) in accordance with the present invention;

FIG. 2 is a schematic block diagram of an embodiment of a computing core in accordance with the present invention;

FIG. 3 is a schematic block diagram of an example of dispersed storage error encoding of data in accordance with the present invention;

FIG. 4 is a schematic block diagram of a generic example of an error encoding function in accordance with the present invention;

FIG. 5 is a schematic block diagram of a specific example of an error encoding function in accordance with the present invention;

FIG. 6 is a schematic block diagram of an example of a slice name of an encoded data slice (EDS) in accordance with the present invention;

FIG. 7 is a schematic block diagram of an example of dispersed storage error decoding of data in accordance with the present invention;

FIG. 8 is a schematic block diagram of a generic example of an error decoding function in accordance with the present invention;

FIG. 9A is a schematic block diagram of an embodiment of a dispersed hierarchical index portion in accordance with the present invention;

FIG. 9B is a schematic block diagram of an embodiment of a dispersed storage network (DSN) in accordance with the present invention;

FIG. 10A is a logic diagram of an example of a method of processing an access request in accordance with the present invention; and

FIG. 10B is a logic diagram of an example of a method of processing an access request in accordance with the present invention.

### DETAILED DESCRIPTION OF THE INVENTION

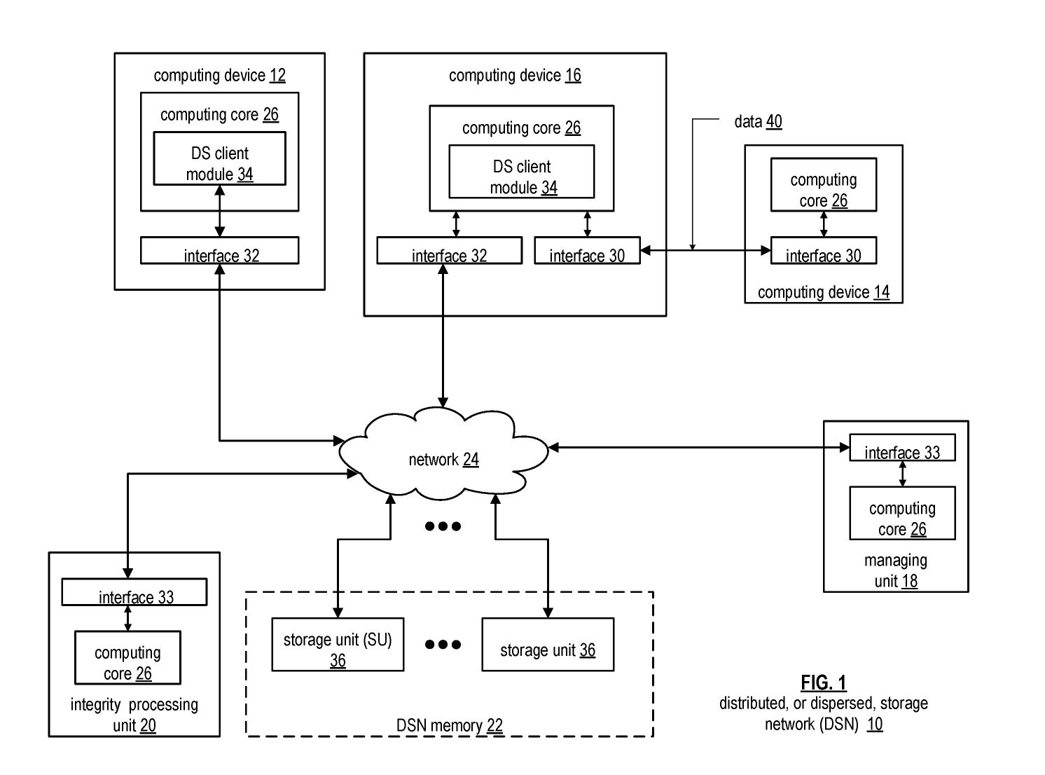

FIG. 1 is a schematic block diagram of an embodiment of a dispersed, or distributed, storage network (DSN) 10 that includes a plurality of computing devices 12-16, a managing unit 18, an integrity processing unit 20, and a DSN memory 22. The components of the DSN 10 are coupled to a network 24, which may include one or more wireless and/or wire lined communication systems; one or more non-public intranet systems and/or public internet systems; and/or one or more local area networks (LAN) and/or wide area networks (WAN).

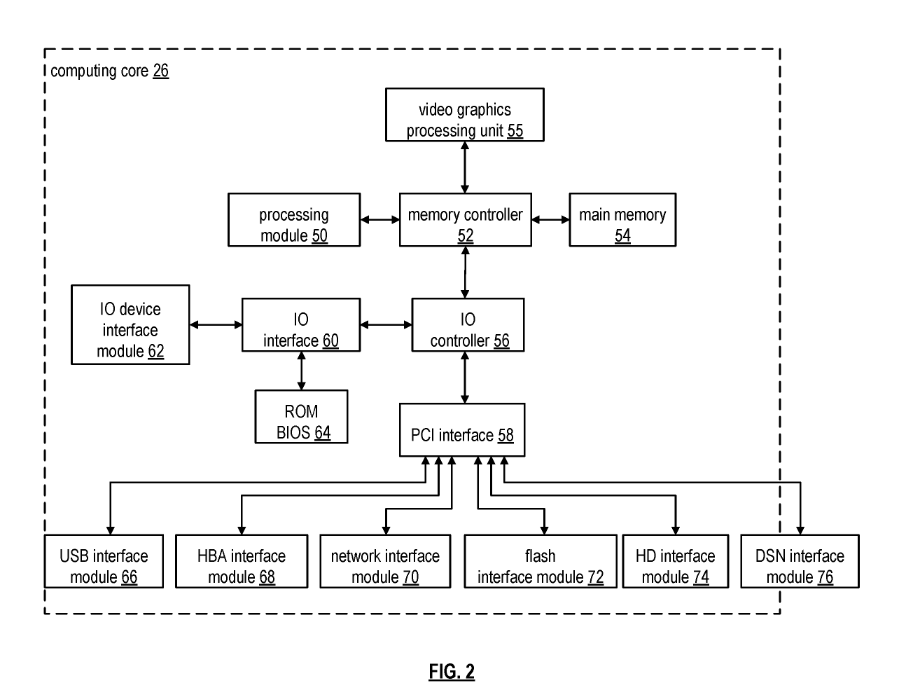

The DSN memory 22 includes a plurality of storage units 36 that may be located at geographically different sites (e.g., one in Chicago, one in Milwaukee, etc.), at a common site, or a combination thereof. For example, if the DSN memory 22 includes eight storage units 36, each storage unit is located at a different site. As another example, if the DSN memory 22 includes eight storage units 36, all eight storage units are located at the same site. As yet another example, if the DSN memory 22 includes eight storage units 36, a first pair of storage units are at a first common site, a second pair of storage units are at a second common site, a third pair of storage units are at a third common site, and a fourth pair of storage units are at a fourth common site. Note that a DSN memory 22 may include more or less than eight storage units 36. Further note that each storage unit 36 includes a computing core (as shown in FIG. 2, or components thereof) and a plurality of memory devices for storing dispersed error encoded data.

In various embodiments, each of the storage units operates as a distributed storage and task (DST) execution unit, and is operable to store dispersed error encoded data and/or to execute, in a distributed manner, one or more tasks on data. The tasks may be a simple function (e.g., a mathematical function, a logic function, an identify function, a find function, a search engine function, a replace function, etc.), a complex function (e.g., compression, human and/or computer language translation, text-to-voice conversion, voice-to-text conversion, etc.), multiple simple and/or complex functions, one or more algorithms, one or more applications, etc. Hereafter, a storage unit may be interchangeably referred to as a dispersed storage and task (DST) execution unit and a set of storage units may be interchangeably referred to as a set of DST execution units.

Each of the computing devices 12-16, the managing unit 18, and the integrity processing unit 20 include a computing core 26, which includes network interfaces 30-33. Computing devices 12-16 may each be a portable computing device and/or a fixed computing device. A portable computing device may be a social networking device, a gaming device, a cell phone, a smart phone, a digital assistant, a digital music player, a digital video player, a laptop computer, a handheld computer, a tablet, a video game controller, and/or any other portable device that includes a computing core. A fixed computing device may be a computer (PC), a computer server, a cable set-top box, a satellite receiver, a television set, a printer, a fax machine, home entertainment equipment, a video game console, and/or any type of home or office computing equipment. Note that each managing unit 18 and the integrity processing unit 20 may be separate computing devices, may be a common computing device, and/or may be integrated into one or more of the computing devices 12-16 and/or into one or more of the storage units 36. In various embodiments, computing devices 12-16 can include user devices and/or can be utilized by a requesting entity generating access requests, which can include requests to read or write data to storage units in the DSN.

Each interface 30, 32, and 33 includes software and hardware to support one or more communication links via the network 24 indirectly and/or directly. For example, interface 30 supports a communication link (e.g., wired, wireless, direct, via a LAN, via the network 24, etc.) between computing devices 14 and 16. As another example, interface 32 supports communication links (e.g., a wired connection, a wireless connection, a LAN connection, and/or any other type of connection to/from the network 24) between computing devices 12 & 16 and the DSN memory 22. As yet another example, interface 33 supports a communication link for each of the managing unit 18 and the integrity processing unit 20 to the network 24.

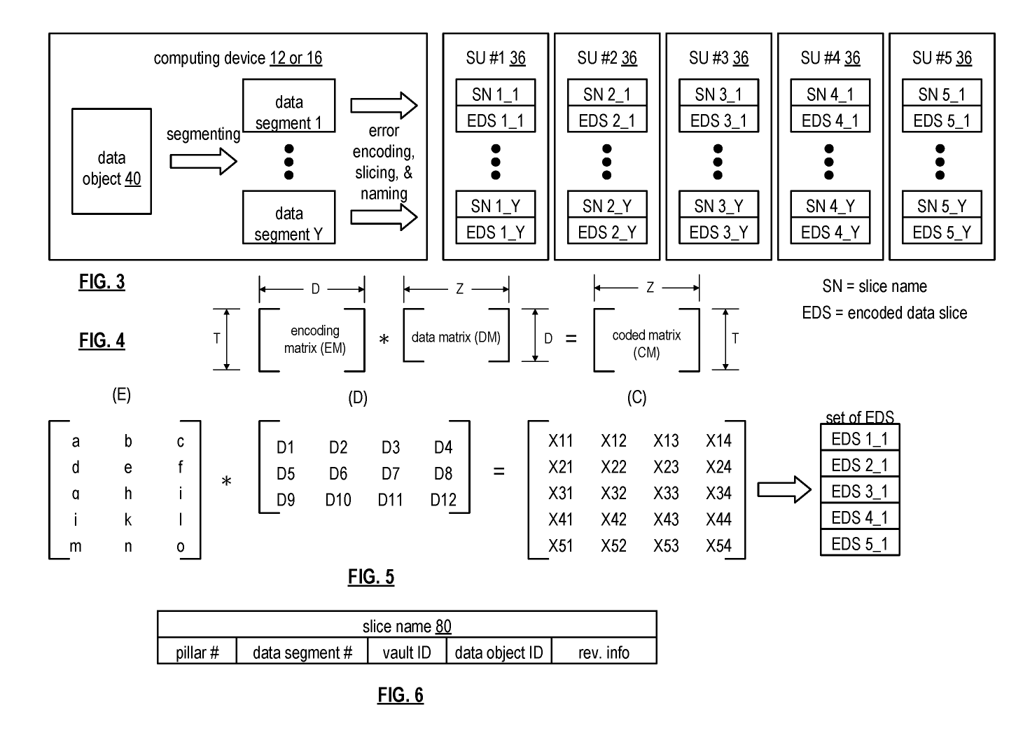

Computing devices 12 and 16 include a dispersed storage (DS) client module 34, which enables the computing device to dispersed storage error encode and decode data as subsequently described with reference to one or more of FIGS. 3-8. In this example embodiment, computing device 16 functions as a dispersed storage processing agent for computing device 14. In this role, computing device 16 dispersed storage error encodes and decodes data on behalf of computing device 14. With the use of dispersed storage error encoding and decoding, the DSN 10 is tolerant of a significant number of storage unit failures (the number of failures is based on parameters of the dispersed storage error encoding function) without loss of data and without the need for a redundant or backup copies of the data. Further, the DSN 10 stores data for an indefinite period of time without data loss and in a secure manner (e.g., the system is very resistant to unauthorized attempts at accessing the data).

In operation, the managing unit 18 performs DS management services. For example, the managing unit 18 establishes distributed data storage parameters (e.g., vault creation, distributed storage parameters, security parameters, billing information, user profile information, etc.) for computing devices 12-14 individually or as part of a group of user devices. As a specific example, the managing unit 18 coordinates creation of a vault (e.g., a virtual memory block associated with a portion of an overall namespace of the DSN) within the DSN memory 22 for a user device, a group of devices, or for public access and establishes per vault dispersed storage (DS) error encoding parameters for a vault. The managing unit 18 facilitates storage of DS error encoding parameters for each vault by updating registry information of the DSN 10, where the registry information may be stored in the DSN memory 22, a computing device 12-16, the managing unit 18, and/or the integrity processing unit 20.

The DSN managing unit 18 creates and stores user profile information (e.g., an access control list (ACL)) in local memory and/or within memory of the DSN memory 22. The user profile information includes authentication information, permissions, and/or the security parameters. The security parameters may include encryption/decryption scheme, one or more encryption keys, key generation scheme, and/or data encoding/decoding scheme.

The DSN managing unit 18 creates billing information for a particular user, a user group, a vault access, public vault access, etc. For instance, the DSN managing unit 18 tracks the number of times a user accesses a non-public vault and/or public vaults, which can be used to generate a per-access billing information. In another instance, the DSN managing unit 18 tracks the amount of data stored and/or retrieved by a user device and/or a user group, which can be used to generate a per-data-amount billing information.

As another example, the managing unit 18 performs network operations, network administration, and/or network maintenance. Network operations includes authenticating user data allocation requests (e.g., read and/or write requests), managing creation of vaults, establishing authentication credentials for user devices, adding/deleting components (e.g., user devices, storage units, and/or computing devices with a DS client module 34) to/from the DSN 10, and/or establishing authentication credentials for the storage units 36. Network administration includes monitoring devices and/or units for failures, maintaining vault information, determining device and/or unit activation status, determining device and/or unit loading, and/or determining any other system level operation that affects the performance level of the DSN 10. Network maintenance includes facilitating replacing, upgrading, repairing, and/or expanding a device and/or unit of the DSN 10.

The integrity processing unit 20 performs rebuilding of ‘bad’ or missing encoded data slices. At a high level, the integrity processing unit 20 performs rebuilding by periodically attempting to retrieve/list encoded data slices, and/or slice names of the encoded data slices, from the DSN memory 22. For retrieved encoded slices, they are checked for errors due to data corruption, outdated version, etc. If a slice includes an error, it is flagged as a ‘bad’ slice. For encoded data slices that were not received and/or not listed, they are flagged as missing slices. Bad and/or missing slices are subsequently rebuilt using other retrieved encoded data slices that are deemed to be good slices to produce rebuilt slices. The rebuilt slices are stored in the DSN memory 22.

FIG. 2 is a schematic block diagram of an embodiment of a computing core 26 that includes a processing module 50, a memory controller 52, main memory 54, a video graphics processing unit 55, an input/output (IO) controller 56, a peripheral component interconnect (PCI) interface 58, an 10 interface module 60, at least one IO device interface module 62, a read only memory (ROM) basic input output system (BIOS) 64, and one or more memory interface modules. The one or more memory interface module(s) includes one or more of a universal serial bus (USB) interface module 66, a host bus adapter (HBA) interface module 68, a network interface module 70, a flash interface module 72, a hard drive interface module 74, and a DSN interface module 76.

The DSN interface module 76 functions to mimic a conventional operating system (OS) file system interface (e.g., network file system (NFS), flash file system (FFS), disk file system (DFS), file transfer protocol (FTP), web-based distributed authoring and versioning (WebDAV), etc.) and/or a block memory interface (e.g., small computer system interface (SCSI), internet small computer system interface (iSCSI), etc.). The DSN interface module 76 and/or the network interface module 70 may function as one or more of the interface 30-33 of FIG. 1. Note that the IO device interface module 62 and/or the memory interface modules 66-76 may be collectively or individually referred to as IO ports.

FIG. 3 is a schematic block diagram of an example of dispersed storage error encoding of data. When a computing device 12 or 16 has data to store it disperse storage error encodes the data in accordance with a dispersed storage error encoding process based on dispersed storage error encoding parameters. Here, the computing device stores data object 40, which can include a file (e.g., text, video, audio, etc.), or other data arrangement. The dispersed storage error encoding parameters include an encoding function (e.g., information dispersal algorithm (IDA), Reed-Solomon, Cauchy Reed-Solomon, systematic encoding, non-systematic encoding, on-line codes, etc.), a data segmenting protocol (e.g., data segment size, fixed, variable, etc.), and per data segment encoding values. The per data segment encoding values include a total, or pillar width, number (T) of encoded data slices per encoding of a data segment i.e., in a set of encoded data slices); a decode threshold number (D) of encoded data slices of a set of encoded data slices that are needed to recover the data segment; a read threshold number (R) of encoded data slices to indicate a number of encoded data slices per set to be read from storage for decoding of the data segment; and/or a write threshold number (W) to indicate a number of encoded data slices per set that must be accurately stored before the encoded data segment is deemed to have been properly stored. The dispersed storage error encoding parameters may further include slicing information (e.g., the number of encoded data slices that will be created for each data segment) and/or slice security information (e.g., per encoded data slice encryption, compression, integrity checksum, etc.).

In the present example, Cauchy Reed-Solomon has been selected as the encoding function (a generic example is shown in FIG. 4 and a specific example is shown in FIG. 5); the data segmenting protocol is to divide the data object into fixed sized data segments; and the per data segment encoding values include: a pillar width of 5, a decode threshold of 3, a read threshold of 4, and a write threshold of 4. In accordance with the data segmenting protocol, the computing device 12 or 16 divides data object 40 into a plurality of fixed sized data segments (e.g., 1 through Y of a fixed size in range of Kilo-bytes to Tera-bytes or more). The number of data segments created is dependent of the size of the data and the data segmenting protocol.

The computing device 12 or 16 then disperse storage error encodes a data segment using the selected encoding function (e.g., Cauchy Reed-Solomon) to produce a set of encoded data slices. FIG. 4 illustrates a generic Cauchy Reed-Solomon encoding function, which includes an encoding matrix (EM), a data matrix (DM), and a coded matrix (CM). The size of the encoding matrix (EM) is dependent on the pillar width number (T) and the decode threshold number (D) of selected per data segment encoding values. To produce the data matrix (DM), the data segment is divided into a plurality of data blocks and the data blocks are arranged into D number of rows with Z data blocks per row. Note that Z is a function of the number of data blocks created from the data segment and the decode threshold number (D). The coded matrix is produced by matrix multiplying the data matrix by the encoding matrix.

FIG. 5 illustrates a specific example of Cauchy Reed-Solomon encoding with a pillar number (T) of five and decode threshold number of three. In this example, a first data segment is divided into twelve data blocks (D1-D12). The coded matrix includes five rows of coded data blocks, where the first row of X11-X14 corresponds to a first encoded data slice (EDS 1_1), the second row of X21-X24 corresponds to a second encoded data slice (EDS 2_1), the third row of X31-X34 corresponds to a third encoded data slice (EDS 3_1), the fourth row of X41-X44 corresponds to a fourth encoded data slice (EDS 4_1), and the fifth row of X51-X54 corresponds to a fifth encoded data slice (EDS 5_1). Note that the second number of the EDS designation corresponds to the data segment number.

Returning to the discussion of FIG. 3, the computing device also creates a slice name (SN) for each encoded data slice (EDS) in the set of encoded data slices. A typical format for a slice name 80 is shown in FIG. 6. As shown, the slice name (SN) 80 includes a pillar number of the encoded data slice (e.g., one of 1-T), a data segment number (e.g., one of 1-Y), a vault identifier (ID), a data object identifier (ID), and may further include revision level information of the encoded data slices. The slice name functions as, at least part of, a DSN address for the encoded data slice for storage and retrieval from the DSN memory 22.

As a result of encoding, the computing device 12 or 16 produces a plurality of sets of encoded data slices, which are provided with their respective slice names to the storage units for storage. As shown, the first set of encoded data slices includes EDS 1_1 through EDS 5_1 and the first set of slice names includes SN 1_1 through SN 5_1 and the last set of encoded data slices includes EDS 1_Y through EDS 5_Y and the last set of slice names includes SN 1_Y through SN 5_Y.

FIG. 7 is a schematic block diagram of an example of dispersed storage error decoding of a data object that was dispersed storage error encoded and stored in the example of FIG. 4. In this example, the computing device 12 or 16 retrieves from the storage units at least the decode threshold number of encoded data slices per data segment. As a specific example, the computing device retrieves a read threshold number of encoded data slices.

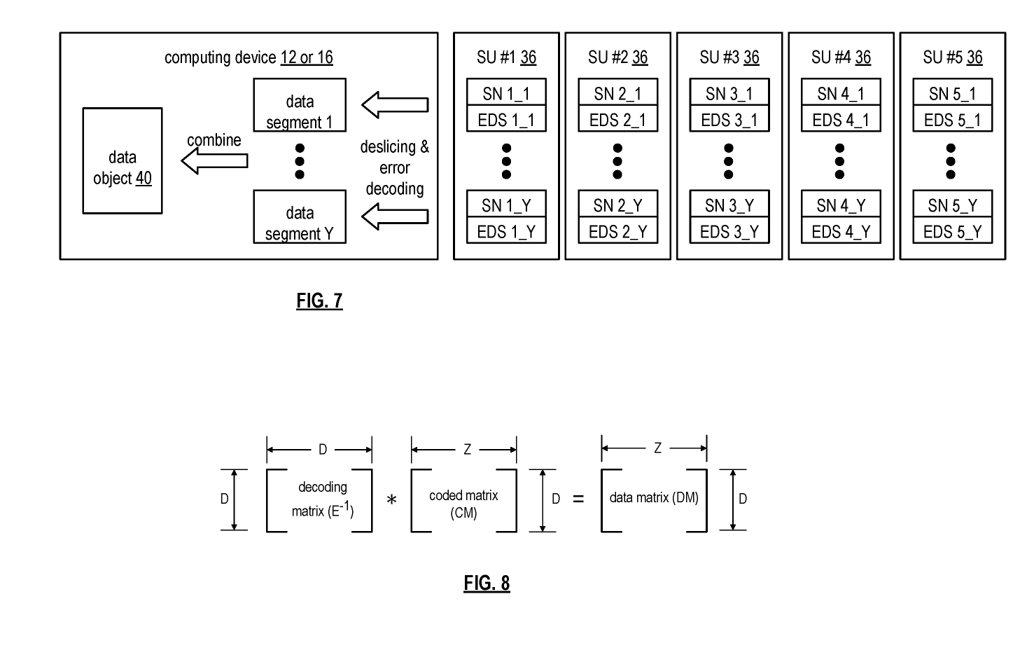

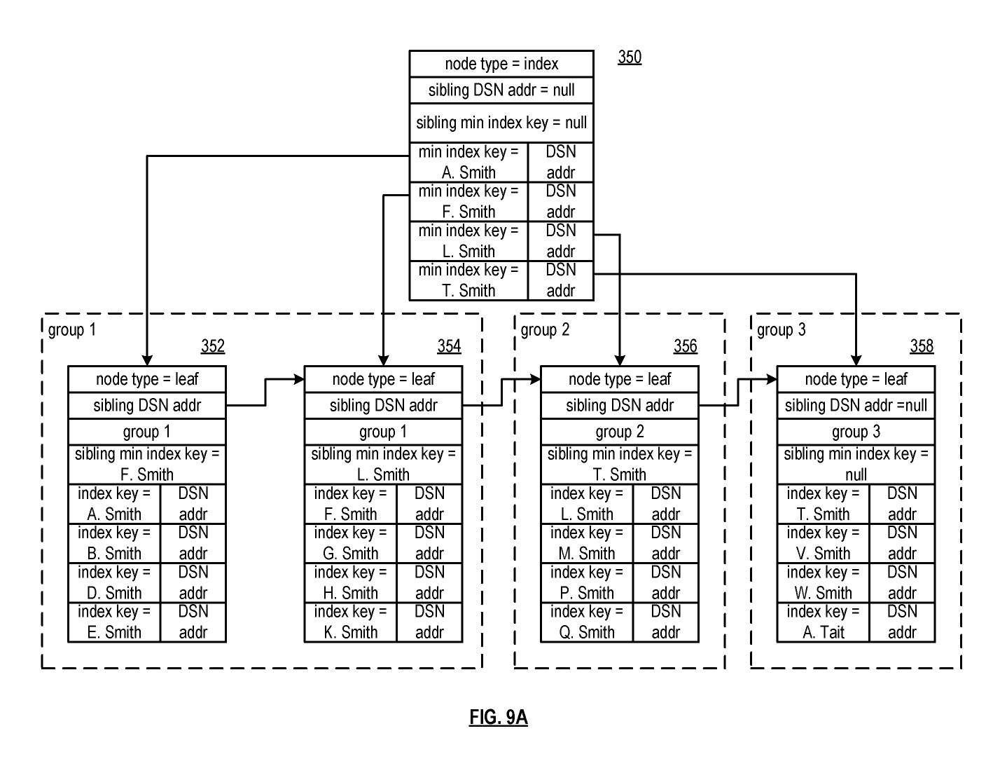

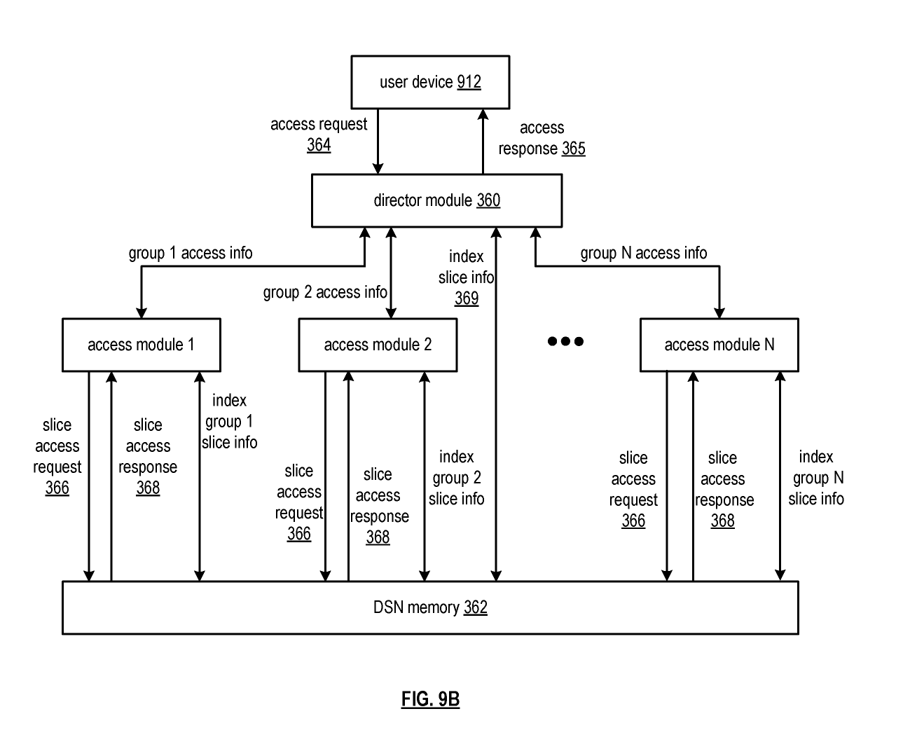

To recover a data segment from a decode threshold number of encoded data slices, the computing device uses a decoding function as shown in FIG. 8. As shown, the decoding function is essentially an inverse of the encoding function of FIG. 4. The coded matrix includes a decode threshold number of rows (e.g., three in this example) and the decoding matrix in an inversion of the encoding matrix that includes the corresponding rows of the coded matrix. For example, if the coded matrix includes rows 1, 2, and 4, the encoding matrix is reduced to rows 1, 2, and 4, and then inverted to produce the decoding matrix.

FIG. 9A is a diagram of an embodiment of a structure of a dispersed hierarchical index portion that includes an index node 350 and a plurality of leaf nodes 352, 354, 356, and 358. The index node 350 includes one or more of a node type entry indicating an index node type in a node type field, a null sibling dispersed storage network (DSN) address entry in a sibling DSN address field, a null entry sibling minimum index key entry in a sibling minimum index key field, and a plurality of child node entries in a plurality of child node fields, where each child node field includes a minimum index key field and a DSN address field associated with a corresponding child node. Each leaf node 352-358 includes one or more of a node type entry indicating a leaf node in a node type field, a sibling DSN address entry in a sibling DSN address field, a group entry in a resource group field, a sibling minimum index key entry in a sibling minimum index key field, and a plurality of data object entries in a plurality of data object fields, where each data object field includes an index key field and a corresponding DSN address field.

Requests for named objects in a DSN can be redirected to a certain computing device or other DS client module based on the name of the object(s) being accessed. For example, read, write, or delete requests for objects with names starting with G to names starting with J may all be directed to one computing device 12-16, while requests for objects with names K-M may go to another. Since access requests to named object translate to operations on a dispersed index, conflicts in index updates can be reduced by partitioning access requests for parts of the index through unique clients to the DSN memory. This approach can apply to any dispersed index operations, where by the index keys are partitioned across different computing devices 12-16 or other elements of the DSN.

Each of the plurality of leaf nodes 352-358 are associated with one or more resource groups, where a resource group includes one or more dispersed storage network (DSN) resource elements (e.g., a dispersed storage (DS) processing unit, a DS unit, a set of DS units, a DS client module 34 of FIG. 1, a computing device 12 or 16 of FIG. 1, a storage unit 36 of FIG. 1 etc.). For example, resource group 1 includes an association with leaf nodes 352-354, resource group 2 includes an association with leaf node 356, and resource group 3 includes an association with leaf node 358. Each of the plurality of leaf nodes 352-358 are child nodes with respect to the index node 350. Leaf node 354 is a sibling node to leaf node 352, leaf node 356 is a sibling node to leaf node 354, leaf node 358 is a sibling node to leaf node 356, and leaf node 358 has no sibling node.

The plurality of leaf nodes 352-358 includes a corresponding plurality of data object index keys that are ordered in accordance with ordering of attributes of an attribute category where each data object index key of the plurality of data object index keys uniquely identifies one of a plurality of data objects stored in the DSN in accordance with the attribute category. For example, the plurality of leaf nodes 352-358 includes a plurality of data object index keys that includes names of a portion of a phonebook where the plurality of object keys are ordered in accordance with an alphabetical ordering of an alphabetical attribute category. For instance, leaf node 352 includes index keys for phonebook names A. Smith through E. Smith, leaf node 354 includes index keys for phonebook names F. Smith through K. Smith, leaf node 356 includes index keys for phonebook names L. Smith through Q. Smith, and leaf node 358 includes index keys for phonebook names T. Smith through A. Tait. The data object index key identifies the one of the plurality of data objects by an associated DSN address that corresponds to a storage location for the one of the plurality of data objects within a DSN. For example, the associated DSN address is utilized to generate a plurality of sets of slice names associated with a plurality of sets of encoded data slices, where the one of the plurality of data objects is encoded using a dispersed storage error coding function to produce the plurality of sets of encoded data slices.

The dispersed index enables generation of a data index list that identifies data objects having one or more common attributes of an attribute category where indexing of the plurality of data objects is organized in accordance with the ordering of attributes of the attribute category. For example, generation of a data index list includes identifying data objects associated with data object index keys G. Smith, H. Smith, K. Smith, L. Smith, and M. Smith when the one or more common attributes includes identifying data objects associated with data object index keys starting with G. Smith and ending with M. Smith and the attribute category includes alphabetized names. As another example, generation of a data index list includes identifying data objects associated with data object index keys Q. Smith, T. Smith, V. Smith, W. Smith, and A. Tait when the one or more common attributes includes identifying data objects associated with data object index keys starting with Q. Smith and higher (e.g., in an ascending alphabetized ordering) and the attribute category includes alphabetized names. As yet another example, generation of a data index list includes identifying data objects associated with data object index keys F. Smith, E. Smith, D. Smith, B. Smith, and A. Smith when the one or more common attributes includes identifying data objects associated with data object index keys starting with F. Smith and lower (e.g., in a descending alphabetized ordering) and the attribute category includes alphabetized names.

In an example of operation, a request is received to retrieve a data object associated with an index key value of G. Smith. The hierarchical ordered index structure that maps the indexing of the plurality of data objects is searched to identify data object level leaf node 354 of the index structure that includes a data object index key (e.g., G. Smith) corresponding to the data object. A resource group 1 entry corresponding to leaf node 354 is extracted from leaf node 354. The request is forwarded to an access module resource (e.g., a DS processing unit) that corresponds to resource group 1 to facilitate retrieving the data object.

FIG. 9B is a schematic block diagram of an embodiment of a dispersed storage network (DSN) system that includes a user device 912, at least one director module 360, a plurality of N access modules, and a dispersed storage network (DSN) memory 362. The user device 912 can be implemented by utilizing the computing device 12 of FIG. 1 or another device with a processor and memory that is associated with a user. The director module 360 may be implemented by at least one of the user device 912, an access module, a processing module, the computing device 16 of FIG. 1, and/or a dispersed storage (DS) client module 34 of FIG. 1. Each access module may be implemented by at least one of a processing module, a user device, the computing device 16 of FIG. 1, and/or a dispersed storage (DS) client module 34 of FIG. 1.

An example of operation, the user device 912 issues an access request 364 (e.g., write, read) to the director module 360, where the request includes an object name. The director module 360 searches a dispersed hierarchical index stored as one or more sets of encoded index slices in the DSN memory 362 based on the object name to identify a resource group. For example, the director module exchanges index slice information 369 with the DSN memory 362 to identify and retrieve slices of one or more nodes of the dispersed hierarchical index based on a searchable attribute associated with the object name. The director module 360 identifies an access module of the plurality of access modules associated with the identified resource group. The director module 360 issues group access information to the identified access module, where the group access information includes the access request 364. For instance, one of, group 1 access information is sent to access module 1, group 2 access information is sent to access module 2, through group N access information is sent to access module N.

The access module issues slice access requests 366 (e.g., write slice requests, read slice requests) to the DSN memory 362 based on the group access information and receives slice access responses 368 (e.g., write slice responses, read slice responses) from the DSN memory in response to the requests. The access module may update the dispersed hierarchical index by exchanging index group slice information with the DSN memory (e.g., index group 1 slice information is associated with access module 1, index group 2 slice information is associated with access module 2, through group index N slice information is associated with access module N). For example, when writing data, the index group slice information includes write slice requests that includes new encoded index slices associated with a leaf node associated with a data object of the object name (e.g., adding a data object entry to the leaf node that includes an index key associated with the data object and a DSN address utilized to store the data object in the DSN).

Next, the access module sends group access information to the director module 360, where the group access information includes a response based on the slice access responses 368 (e.g., a write acknowledgment, the data object when the data object has been read). The director module 360 issues an access response 365 to the user device 912 based on the group access information received from the access module (e.g., forwards the response generated by the access module).

In various embodiments, a processing system of a director module includes at least one processor and a memory that stores operational instructions, that when executed by the at least one processor cause the processing system to receive an access request that includes a searchable identifier. A dispersed hierarchical index is searched using the searchable identifier to identify a resource group. Group access information that includes the access request is issued to an access module associated with the resource group. The access module accesses a DSN memory based on the group access information and updates the dispersed hierarchical index with regards to the resource group. Further group access information is received from the access module. An access response is issued to a requesting entity based on the further group access information.

In various embodiments, the dispersed hierarchical index includes a plurality of leaf nodes that include a corresponding plurality of data object index keys that are ordered in accordance with ordering of attributes of an attribute category, where each data object index key of the plurality of data object index keys uniquely identifies one of a plurality of data objects stored in the DSN memory in accordance with the attribute category, and where the plurality of data objects are stored in a plurality of storage units of the DSN memory as corresponding sets of encoded slices produced by dispersed storage error encoding the plurality of data objects. In various embodiments, searching the dispersed hierarchical index includes identifying a leaf node associated with the searchable identifier and extracting a resource group identifier from the leaf node to identify the resource group. In various embodiments, searching the dispersed hierarchical index includes exchanging index slice information with the DSN memory to identify and retrieve slices of at least one nodes of the dispersed hierarchical index based on the searchable identifier, where the searchable identifier is based on an object name associated with a data object for access.

In various embodiments, issuing the group access information includes identifying the access module based on the identified resource group. The group access information is generated to include the access request, contents of a leaf node associated with the searchable identifier, and a DSN address associated with a data object for access. The group access information is sent to the access module. In various embodiments, the DSN address is associated with an encoded slice of a set of encoded data slices associated with the data object, where the data object was dispersed storage error encoded to produce the set of encoded data slices for storage in a set of storage units of the DSN memory.

In various embodiments, the access module issues slice access requests to the DSN memory using a DSN address associated with a data object indicated in the access request, receives slice access responses from the DSN memory, and generates a response for transmission to the director module based on the slice access responses. The response is received from the access module. In various embodiments, the access request includes a delete request that indicates a data object. The access module updates the dispersed hierarchical index by deleting an entry of a leaf node corresponding to the data object, where the entry corresponds to the data object. In various embodiments, the access request includes a write request that indicates a data object. The access module updates the dispersed hierarchical index by adding an entry to a leaf node corresponding to the data object, where the entry corresponds to the data object. In various embodiment, the further group access information includes a response based on slice access responses to the access module, and the access response includes the response.

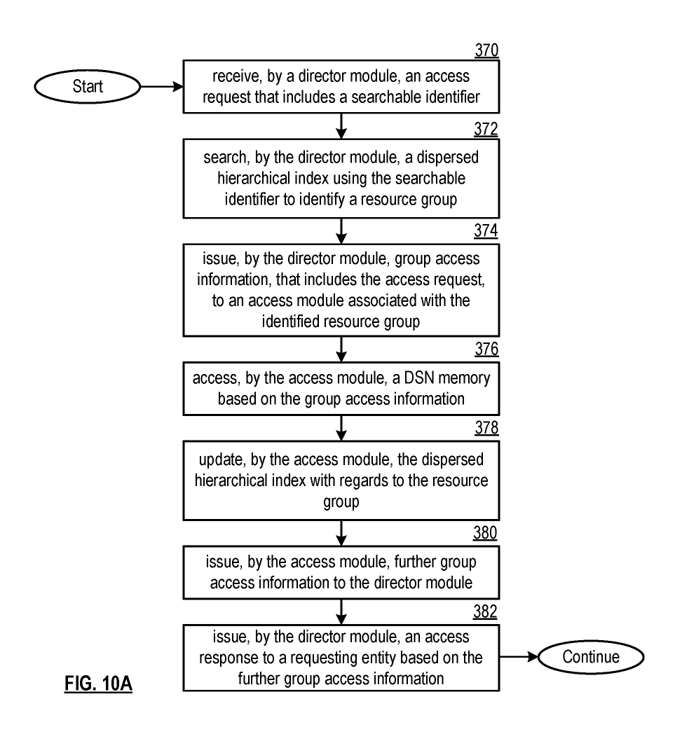

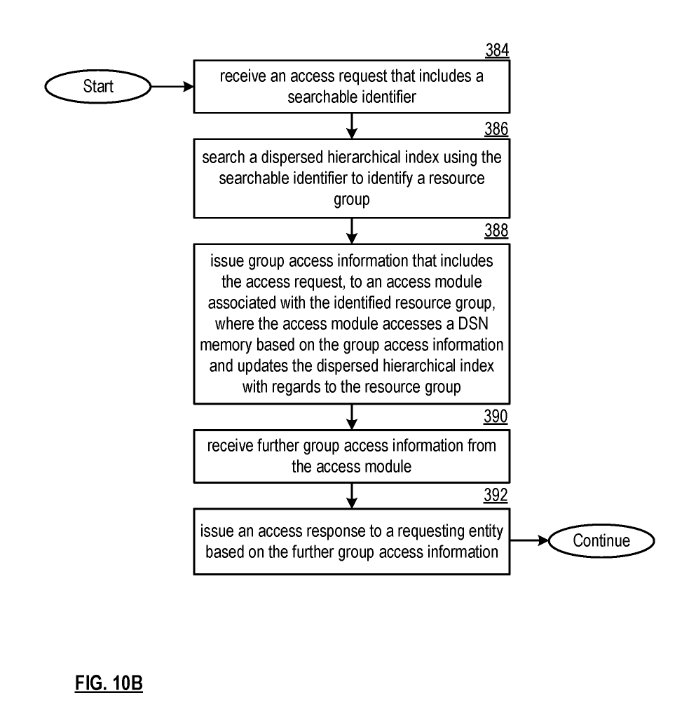

FIG. 10A is a flowchart illustrating an example of processing an access request. In particular, a method is presented for use in association with one or more functions and features described in conjunction with FIGS. 1-9, for execution in a DSN that includes an access module and a director module.

The method begins at step 370 where a director module receives an access request that includes a searchable identifier. The searchable identifier can include at least one of an object name, a data type, a user identifier, a data owner identifier, and/or a data attribute. The method continues at step 372 where the director module searches a dispersed hierarchical index using the searchable identifier to identify a resource group. The dispersed hierarchical index can be stored in one or more of a local memory associated with the director module and a dispersed storage network (DSN) memory. The dispersed hierarchical index can include a plurality of leaf nodes that include a corresponding plurality of data object index keys that are ordered in accordance with ordering of attributes of an attribute category, where each data object index key of the plurality of data object index keys uniquely identifies one of a plurality of data objects stored in the DSN memory in accordance with the attribute category, and where the plurality of data objects are stored in a plurality of storage units of the DSN memory as corresponding sets of encoded slices produced by dispersed storage error encoding the plurality of data objects. The searching can include identifying a leaf node associated with the searchable identifier (e.g., best match in accordance with a searching approach) and/or extracting a resource group identifier from the identified leaf node. The searching can include exchanging index slice information with the DSN memory to identify and retrieve slices of at least one node of the dispersed hierarchical index based on the searchable identifier, where the searchable identifier is based on an object name associated with a data object for access.

The method continues at step 374 where the director module issues group access information to an access module associated with the identified resource group, where the group access information includes the access request. The issuing can include identifying the access module based on the identified resource group (e.g., initiating a query, accessing a list, receiving an identifier of the access module); generating the group access information to include one or more of the access request, contents of the leaf node associated with the searchable identifier, and/or a DSN address associated with a data object for access; and/or sending the group access information to the identified access module. The method continues at step 376 where the access module accesses the DSN memory based on the group access information. For example, the access module can issue slice access requests to the DSN memory using the DSN address associated with the data object for access, receive slice access responses from the DSN memory, and/or generate a response based on the slice access responses. The DSN address can be associated with an encoded slice of a set of encoded data slices associated with the data object, where the data object was dispersed storage error encoded to produce the set of encoded data slices for storage in a set of storage units of the DSN memory.

The method continues at step 378 where the access module updates the dispersed hierarchical index with regards to the resource group. The updating can include determining whether to update the dispersed hierarchical index based on the access request and/or updating the dispersed hierarchical index when the access module determines to perform the update. For example, the access module determines to update the dispersed hierarchical index when the access request includes at least one of a write request and a delete request. For instance, when the access request includes the delete request, the access module updates the dispersed hierarchical index to delete an entry of the leaf node corresponding to the data object, where the entry corresponds to the data object. As another instance, when the access request includes the write request, the access module updates the dispersed hierarchical index to add an entry to the leaf node corresponding to the data object, where the entry corresponds to the data object.

The method continues at step 380 where the access module issues further group access information to the director module. The issuing can include generating the further group access information to include the response based on the slice access responses and sending the further group access information to the director module. The method continues at step 382 where the director module issues an access response to a requesting entity based on the further group access information. The issuing can include generating the access response to include the response based on the slice access responses and sending the access response to the requesting entity.

FIG. 10B is a flowchart illustrating an example of processing an access request. In particular, a method is presented for use in association with one or more functions and features described in conjunction with FIGS. 1-9, for execution by a director module that includes a processor or via another processing system of a dispersed storage network that includes at least one processor and memory that stores instruction that configure the processor or processors to perform the steps described below. Step 384 includes receiving an access request that includes a searchable identifier. Step 386 includes searching a dispersed hierarchical index using the searchable identifier to identify a resource group. Step 388 includes issuing group access information that includes the access request, to an access module associated with the identified resource group, where the access module accesses a DSN memory based on the group access information and updates the dispersed hierarchical index with regards to the resource group. Step 390 includes receiving further group access information from the access module. Step 392 includes issuing an access response to a requesting entity based on the further group access information.

In various embodiments, a non-transitory computer readable storage medium includes at least one memory section that stores operational instructions that, when executed by a processing system of a dispersed storage network (DSN) that includes a processor and a memory, causes the processing system to receive an access request that includes a searchable identifier. A dispersed hierarchical index is searched using the searchable identifier to identify a resource group. Group access information that includes the access request is issued to an access module associated with the resource group. The access module accesses a DSN memory based on the group access information and updates the dispersed hierarchical index with regards to the resource group. Further group access information is received from the access module. An access response is issued to a requesting entity based on the further group access information.

It is noted that terminologies as may be used herein such as bit stream, stream, signal sequence, etc. (or their equivalents) have been used interchangeably to describe digital information whose content corresponds to any of a number of desired types (e.g., data, video, speech, audio, etc. any of which may generally be referred to as ‘data’).

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may also be used herein, the terms “processing system”, “processing module”, “processing circuit”, “processor”, and/or “processing unit” may be used interchangeably, and may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing system, processing module, module, processing circuit, and/or processing unit may be, or further include, memory and/or an integrated memory element, which may be a single memory device, a plurality of memory devices, and/or embedded circuitry of another processing system, processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing system, processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing system, processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing system, processing module, module, processing circuit, and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

What is claimed is:

1. A method for execution by a director module that includes a processor, the method comprises:
receiving an access request that includes a searchable identifier;
searching a dispersed hierarchical index using the searchable identifier to identify a resource group;
issuing group access information that includes the access request to an access module associated with the resource group, wherein the access module accesses a DSN memory based on the group access information and updates the dispersed hierarchical index with regards to the resource group;
receiving further group access information from the access module; and
issuing an access response to a requesting entity based on the further group access information.

2. The method of claim 1, wherein searching the dispersed hierarchical index includes:
identifying a leaf node associated with the searchable identifier; and
extracting a resource group identifier from the leaf node to identify the resource group.

3. The method of claim 1, wherein searching the dispersed hierarchical index includes exchanging index slice information with the DSN memory to identify and retrieve slices of at least one nodes of the dispersed hierarchical index based on the searchable identifier, and wherein the searchable identifier is based on an object name associated with a data object for access.

4. The method of claim 1, wherein issuing the group access information includes:
identifying the access module based on the identified resource group;
generating the group access information to include the access request, contents of a leaf node associated with the searchable identifier, and a DSN address associated with a data object for access; and
sending the group access information to the access module.

5. The method of claim 4, wherein the DSN address is associated with an encoded slice of a set of encoded data slices associated with the data object, and wherein the data object was dispersed storage error encoded to produce the set of encoded data slices for storage in a set of storage units of the DSN memory.

6. The method of claim 1, wherein the access module issues slice access requests to the DSN memory using a DSN address associated with a data object indicated in the access request, receives slice access responses from the DSN memory, and generates a response for transmission to the director module based on the slice access responses, and wherein the method further comprises receiving the response from the access module.

7. The method of claim 1, wherein the access request includes a delete request that indicates a data object, and wherein the access module updates the dispersed hierarchical index by deleting an entry of a leaf node corresponding to the data object, and wherein the entry corresponds to the data object.

8. The method of claim 1, wherein the access request includes a write request that indicates a data object, and wherein the access module updates the dispersed hierarchical index by adding an entry to a leaf node corresponding to the data object, and wherein the entry corresponds to the data object.

9. The method of claim 1, wherein the further group access information includes a response based on slice access responses to the access module, and wherein the access response includes the response.

10. The method of claim 1, wherein the dispersed hierarchical index includes a plurality of leaf nodes that include a corresponding plurality of data object index keys that are ordered in accordance with ordering of attributes of an attribute category, wherein each data object index key of the plurality of data object index keys uniquely identifies one of a plurality of data objects stored in the DSN memory in accordance with the attribute category, and wherein the plurality of data objects are stored in a plurality of storage units of the DSN memory as corresponding sets of encoded slices produced by dispersed storage error encoding the plurality of data objects.

11. A processing system of a director module comprises:
at least one processor;
a memory that stores operational instructions, that when executed by the at least one processor cause the processing system to:
receive an access request that includes a searchable identifier;
search a dispersed hierarchical index using the searchable identifier to identify a resource group;
issue group access information that includes the access request to an access module associated with the resource group, wherein the access module accesses a DSN memory based on the group access information and updates the dispersed hierarchical index with regards to the resource group;
receive further group access information from the access module; and
issue an access response to a requesting entity based on the further group access information.

12. The processing system of claim 11, wherein searching the dispersed hierarchical index includes:
identifying a leaf node associated with the searchable identifier; and
extracting a resource group identifier from the leaf node to identify the resource group.

13. The processing system of claim 11, wherein searching the dispersed hierarchical index includes exchanging index slice information with the DSN memory to identify and retrieve slices of at least one node of the dispersed hierarchical index based on the searchable identifier, and wherein the searchable identifier is based on an object name associated with a data object for access.

14. The processing system of claim 11, wherein issuing the group access information includes:
identifying the access module based on the identified resource group;
generating the group access information to include the access request, contents of a leaf node associated with the searchable identifier, and a DSN address associated with a data object for access; and
sending the group access information to the access module.

15. The processing system of claim 14, wherein the DSN address is associated with an encoded slice of a set of encoded data slices associated with the data object, and wherein the data object was dispersed storage error encoded to produce the set of encoded data slices for storage in a set of storage units of the DSN memory.

16. The processing system of claim 11, wherein the access request includes a delete request that indicates a data object, and wherein the access module updates the dispersed hierarchical index by deleting an entry of a leaf node corresponding to the data object, and wherein the entry corresponds to the data object.

17. The processing system of claim 11, wherein the access request includes a write request that indicates a data object, and wherein the access module updates the dispersed hierarchical index by adding an entry to a leaf node corresponding to the data object, and wherein the entry corresponds to the data object.

18. The processing system of claim 11, wherein the further group access information includes a response based on slice access responses to the access module, and wherein the access response includes the response.

19. The processing system of claim 11, wherein the dispersed hierarchical index includes a plurality of leaf nodes that include a corresponding plurality of data object index keys that are ordered in accordance with ordering of attributes of an attribute category, wherein each data object index key of the plurality of data object index keys uniquely identifies one of a plurality of data objects stored in the DSN memory in accordance with the attribute category, and wherein the plurality of data objects are stored in a plurality of storage units of the DSN memory as corresponding sets of encoded slices produced by dispersed storage error encoding the plurality of data objects.

20. A non-transitory computer readable storage medium comprises:
at least one memory section that stores operational instructions that, when executed by a processing system of a dispersed storage network (DSN) that includes a processor and a memory, causes the processing system to:
receive an access request that includes a searchable identifier;
search a dispersed hierarchical index using the searchable identifier to identify a resource group;
issue group access information that includes the access request to an access module associated with the resource group, wherein the access module accesses a DSN memory based on the group access information and updates the dispersed hierarchical index with regards to the resource group;
receive further group access information from the access module; and
issue an access response to a requesting entity based on the further group access information.
